(19) United States
(12) Patent Application Publication
(10) Pub. No.: US 2010/0056100 A1
(43) Pub. Date: Mar. 4, 2010

(54) RULES-BASED ASSOCIATION OF A PHONE NUMBER WITH ONE OR MORE DESTINATION LOCATIONS

(75) Inventors: Adam Elman, Sunnyvale, CA (US); Karen M. Cross, Mountain View, CA (US)

Correspondence Address: PERKINS COIE LLP/MSFT, P. O. BOX 1247, SEATTLE, WA, 98111-1247, US

(73) Assignee: Microsoft Corporation, Redmond, WA (US)

(21) Appl. No.: 12/204,727

(22) Filed: Sep. 4, 2008

(51) Int. Cl. H04W 4/00; H04M 3/42

(52) U.S. Cl. 455/404.1; 455/414.1

(57) ABSTRACT

Systems and methods of rules-based association of a phone number with one or more destination locations are disclosed here. In one aspect, embodiments of the present disclosure include a method, which may be implemented on a system, of associating a phone number with one or more destination locations based on a set of rules and receiving a request from a user using the phone number. The request is associated with accessing a set of directions to at least one of the one or more destination locations. The method may further include, identifying an originating location associated with the request received from the user, and providing the user with at least one of the sets of directions to the one or more destination locations from the originating location.

### BACKGROUND

The prevalence of mobile devices has significantly increased usage of mobile devices and mobile applications for obtaining navigational directions (e.g., step-by-step directions, turn-by-turn directions, less detailed directions, driving, walking, directions, etc.) on the fly. For example, directions may be requested or obtained, either via the web, via centralized services such as 411, or via calling the business/establishment directly.

However, these mechanisms tend to be overly tedious and time consuming for the end user who is on-the-go. Oftentimes, the user will need to perform an initial query to obtain the address for the destination location or any other type of contact information via one mechanism and then submit the results of the query via another mechanism to obtain the desired directions. During this process, the user also frequently needs to provide his/her current location or an originating location for which the direction are to be generated yet further complicating the process of searching for destinations and directions via a mobile device.

For example, the end user may search for the address and phone number of a business location such as the dentist's office via accessing the Internet or calling 411 from the mobile device. Once the address has been obtained, the user subsequently enters the destination address of the dentist's office and the originating address of the user into a web-based service or a mobile application (e.g., Google maps, Yahoo maps, Mapquest, etc.). Alternatively, the user may call the business location and obtain directions from the receptionist or other personnel who may be available to provide directions.

However, this approach may be ineffective, time consuming, and costly for the business as the personnel from whom the directions are requested, may not be familiar with the area where the user is driving from nor familiar with the nearby locale and street names. In general, these approaches tend to be highly inefficient and at times inconvenient for a user that is on the go.

Furthermore, automated services such as 411 are typically limited to maintaining a database for businesses. Therefore, addresses to residents or small businesses with residential addressed are typically not accessible via 411.

### SUMMARY

Systems and methods of rules-based association of a phone number with one or more destination locations are described here. Some embodiments of the present disclosure are summarized in this section.

In one aspect, embodiments of the present disclosure include a method, which may be implemented on a system, of associating a phone number with one or more destination locations based on a set of rules.

Phone numbers (e.g., telephone numbers, cell phone numbers, 1-800 numbers, 1-888 numbers, etc.) can be associated with one or more locations, for example, based on a request placed by a requesting entity which may be a business, establishment, and/or a representative for an event, etc. This phone number can also be referred to as a destination phone number that a caller calls. The requests may be placed via a web-interface or in some other instance, via a telephone interface. The phone numbers are setup such that when users call the phone number, information customized by the business or establishment can be provided to (e.g., delivered via audio or text) the user. Such customized information typically includes the address to the business/establishment and directions to the destination location that are specific to the user.

In some instances, the requesting entity may wish to associate the phone number with multiple destination locations. The associations with the phone number can vary based on a set of rules specified by the requesting entity (business, establishment, a representative for an event, etc.). For example, a dentist may have multiple office locations one which he/she works from during the weekdays and another which he/she works from during the weekends. Therefore, the dentist's phone number can be associated with location A when called on the weekdays and location B when called on the weekends. This is an example of a time-based rule.

Similarly, the rules can be caller-based or based on other attributes associated with a call. For example, if the caller is a delivery person as opposed to a patient, the delivery person may be provided with the address and/or directions for an off-site storage location.

In a further aspect of the present disclosure, a request associated with accessing a set of directions to at least one of the one or more destinations is received from the user using the phone number. For example, the user may call the phone number from a mobile device, a telephone, Skype, and/or VoIP to generate the request. The user may also send a text message to the phone number to generate the request.

In a further aspect of the present disclosure, an originating location associated with the request received from the user is identified.

In most instances, the request is related to accessing directions to a destination location. The directions that are requested are typically directions customized or personalized to a specified originating location or a current location of the requesting user. Therefore, the originating or current location may be automatically provided by the user's device if the device has location-awareness capabilities (e.g., including but not limited to GPS). The user may also manually submit an originating location if different from the user's current location. In instances when the user's device is not location-aware, the user may be prompted to submit a current location or another desired originating location where the user desires the directions to be directed from.

In accordance with further embodiments of the present disclosure, the user is provided with at least one of the sets of directions to the one or more destination locations from the originating location.

The directions may be provided, audibly, via text, via a visual map display, any combination of the above, or any additional convenient and/or known means. In addition, the directions may depend on whether the user is traveling by foot, by car, via public transportation, or via any other means. These preferences may be specified on a case-by-case basis or obtained from the user profile with user-specified (e.g., predetermined) preferences and implied preferences. The preferences can include specifications related to how the user prefers to receive the directions, how the user prefers to travel (e.g., preferred mode of transportation), and/or the level of detail with which the user needs the directions, etc. Note that the preferences can be explicitly specified by the user or collected by the system based on user behavior (e.g., implied user preferences).

The present disclosure includes methods and systems which perform these methods, including processing systems which perform these methods, and computer readable media which when executed on processing systems cause the systems to perform these methods.

Other features of the present disclosure will be apparent from the accompanying drawings and from the detailed description which follows.

### BRIEF DESCRIPTION OF THE DRAWINGS

FIG. 1 illustrates a block diagram of client devices coupled to one another and a host server that provides directions to users of the client devices via a mobile wireless network, telephone network, and/or network.

FIG. 2A depicts a block diagram illustrating an example system to provide directions based on usage of a phone number that is associated with one or more destination locations based on rules, the system to include a host server coupled to a user data repository and/or a telephone number repository.

FIG. 2B is a diagrammatic view illustrating the example interactions between various entities in the process of retrieving or generating directions based on usage of a phone number that is associated with one or more destination locations.

FIG. 3A depicts a block diagram illustrating an example user data repository to store user profiles with specified and/or implied user preferences.

FIG. 3B depicts a block diagram illustrating an example telephone number repository to store phone numbers and their associated locations and/or any applicable rules.

FIG. 4A-B illustrates example user interfaces for a business, establishment, or representative for an event to select a phone number.

FIG. 5A-B illustrates example user interfaces for a business, establishment, or representative for an event to setup customized information associated with the selected telephone number.

FIG. 6A depicts a flow diagram illustrating an example process of providing directions to a user using the phone number associated with one or more destination locations based on a set of rules.

FIG. 6B depicts a table illustrating examples of variables that can be taken into account when generating directions based on a particular destination and originating direction.

FIG. 7 depicts a flow diagram illustrating another example process of providing directions to an associated agent using the phone number associated with a target location.

FIG. 8 shows a diagrammatic representation of a machine in the example form of a computer system within which a set of instructions, for causing the machine to perform any one or more of the methodologies discussed herein, may be executed.

### DETAILED DESCRIPTION

The following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be, but not necessarily are, references to the same embodiment; and, such references mean at least one of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

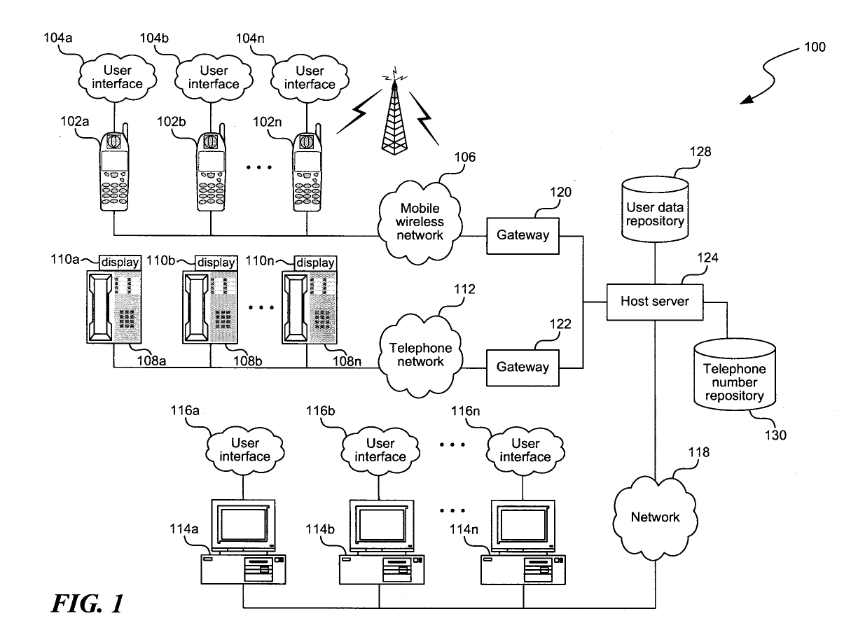

FIG. 1 illustrates a block diagram of client devices 102A-N, 108A-N, 114A-N coupled to one another and a host server 124 that provides directions to users of client devices via a mobile wireless network 106, telephone network 112, and/or network 118, according to one embodiment.

The plurality of client devices (e.g., mobile devices or portable devices) 102A-N can be any system and/or device, and/or any combination of devices/systems that is able to establish a connection with a wireless network (e.g., mobile wireless network 106). The mobile devices 102A-N typically include a screen or other output display functionalities to present data exchanged between the devices to a user, such as to display user interfaces 104A-N. For example, the mobile devices 102A-N can be, but are not limited to, a mobile computing device, a mobile phone, a cellular phone, a VoIP phone, a smart phone, a PDA, a Blackberry device, a Treo, and/or an iPhone, etc.

The plurality of telephonic devices 108A-N can be any system and/or device, and/or any combination of devices/systems that is able to establish a connection with a telephone network 112. The telephonic devices 108A-N typically include a screen 110A-N or other output display functionalities to present data exchanged between the devices to a user, such as to display system or call status. For example, the mobile devices 102A-N can be, but are not limited to, a wired or wireless telephone, a fax machine, an answering machine, mobile phone, a cellular phone, a landline phone, a satellite phone, a PBX phone, a VoIP phone, a smart phone, a PDA, a Blackberry device, a Treo, an iPhone, and/or any other type of communication device able to provide voice communication and/or touch-tone signals over the telephone network 112. In addition, any audio signal carrying interface can be used.

The client devices 114A-N can be any system and/or device, and/or any combination of devices/systems that is able to establish a wired or wireless connection with another device, servers and/or other systems in some instances via a network (e.g., network 118). The client devices 114A-N may also include a screen or other output display functionalities to present data exchanged between the devices to a user, such as, to display user interfaces 116A-N. For example, the client devices 114A-N can be, but are not limited to, a processing unit, a server desktop, a desktop computer, a computer cluster, a mobile computing device such as a notebook, a laptop computer, a handheld computer, a mobile phone, a smart phone, a PDA, a Blackberry device, a VoIP phone, a Treo, and/or an iPhone, etc.

In one embodiment, the mobile devices 102A-N, the telephonic devices 108A-N and client devices 114A-N are coupled via a mobile wireless network 106, gateways 120/122 and the network 118. The host server 124 can be coupled to the mobile devices 102, telephonic devices 108, and the client devices 114 via one or more of the mobile wireless network 106, the telephone network 112, and the network 118.

For example, the wireless network (e.g., mobile wireless network) 106 can be any network able to establish connections with mobile devices 102A-N, such as mobile phones. The wireless network 110 can be, but is not limited to Global System for Mobile Communications (GSM) network, Code Division Multiple Access (CDMA) network, Evolution-Data Optimized (EV-DO) network, Enhanced Data Rates for GSM Evolution (EDGE) network, 3GSM network, Fixed Wireless Data, 2G, 2.5G, 3G networks, General packet radio service (GPRS) network, enhanced GPRS network, Digital Enhanced Cordless Telecommunications (DECT), Digital AMPS (IS-136/TDMA) network, and Integrated Digital Enhanced Network (iDEN).

GSM networks typically provide wireless service providers with the ability to offer roaming services to subscribers when they travel outside of the region (e.g., country) where subscription is based. Communication services provided by the wireless network 106 may further support messaging protocols such as, but is not limited to, Multimedia Messaging Service (MMS), SMS, USSD, IRC, or any other wireless data networks and/or messaging protocols.

In particular, GSM networks typically offer Short message service (SMS), or text messaging services to subscribers, thus allowing, for example, mobile device users (e.g., users of mobile devices 102A-N) to send text messages to one another. SMS is typically supported by mobile standards such as ANSI CDMA networks, 3G, AMPS, satellite, and/or landline networks. The Short Message Service-Point to Point (SMS-PP) is defined in the GSM recommendation 3GPP TS 23.040/3GPP TS 23.041 and is incorporated herein by reference.

The telephone network 112 can be any network able to establish connections with one or more telephone devices 108A-N through any known and/or convenient telephonic protocol. For example, the telephone network 112 can be, but is not limited to, the public switched telephone network (PSTN), the integrated services digital network (ISDN), asymmetric digital subscriber line (ADSL), digital subscriber line (DSL) and/or some other type of telephone network. The telephone network 112 generally represents an audio signal carrying network. Telephonic devices can digitally transmit speech, sound, touch-tone signals, and/or other types of data over the telephone line. The PSTN is largely governed by technical standards created by the ITU-T, and uses E.163/E.164 addressing and is incorporated herein by reference.

The network 118, over which the client devices 114A-N communicate, may be a telephonic network, an open network, such as the Internet, or a private network, such as an intranet and/or the extranet. The client devices 114-N can be coupled to the network (e.g., Internet) via a dial up connection, a digital subscriber loop (DSL, ADSL), cable modem, and/or other types of connection. Thus, the client devices 114A-N can communicate with remote servers (e.g., web server and host server) that provide access to visual interface to the World Wide Web via a web browser, for example.

The Internet can provide services through any known and/or convenient protocol, such as, but is not limited to the TCP/IP protocol, Open System Interconnections (OSI), FTP, UPnP, iSCSI, NSF, ISDN, PDH, RS-232, SDH, SONET, etc. In some embodiments, the network 118 can be any collection of distinct networks operating wholly or partially in conjunction to provide connectivity to the client devices 104A-N, host server 124, and/or the user devices 114A-N and may appear as one or more networks to the serviced systems and devices. In one embodiment, communications can be achieved by a secure communications protocol, such as secure sockets layer (SSL), or transport layer security (TLS).

In addition, communications can be achieved via one or more wired and/or wireless networks, such as, but is not limited to, one or more of a Local Area Network (LAN), Wireless Local Area Network (WLAN), a Personal area network (PAN), a Campus area network (CAN), a Metropolitan area network (MAN), a Wide area network (WAN), a Wireless wide area network (WWAN), Bluetooth, Wi-Fi, messaging protocols such as, TCP/IP, SMS, MMS, extensible messaging and presence protocol (XMPP), real time messaging protocol (RTMP), instant messaging and presence protocol (IMPP), instant messaging, USSD, IRC, or any other wireless data networks or messaging protocols.

The gateways 120 and 122, typically interfaces the mobile wireless network 106 and the telephone network 112 to another network (e.g., network 118) that utilizes one or more different protocols. The gateways 120 and 122 can communicate with one or more components having any combination of software agents and/or hardware modules for facilitating a mobile device operator (e.g., a user of mobile devices 102A-102N) and the telephone operator (e.g., a user of telephone devices 108A-N) to communicate with a client device user (e.g., a user of client devices 108A-N) through a mobile wireless network (e.g., the wireless network 106), a telephone network (e.g., the telephone network 112), and the network 118.

The gateways 120 and 122 can include a number of components such as, but is not limited to, protocol transistors, impedance matching devices, rate converters, fault isolators, and/or signal translators, etc., to interface to one or more networks with different protocols than the protocols under which the original signal was sent. The gateways 120 and 122 can further facilitate the establishment of a set of rules and administrative procedures between different network protocols such that communication can be established. Typically, protocol converters such as gateways can operate at any network layer (e.g., the application layer, the presentation layer, the session layer, the transport layer, the network layer, the data link layer, and/or the physical layer) of the Open System Interconnection (OSI) model and convert one protocol stack into another. For example, a gateway can connect a LAN to the Internet. Similarly, gateways can also connect two IP-based networks.

The user data repository 128 and telephone number repository 130 can store software, descriptive data, images, system information, drivers, and/or any other data item utilized by other components of the host server 124 for operation. The user data repository 128 and telephone number repository 130 may be managed by a database management system (DBMS), for example but not limited to, Oracle, DB2, Microsoft Access, Microsoft SQL Server, PostgreSQL, MySQL, FileMaker, etc.

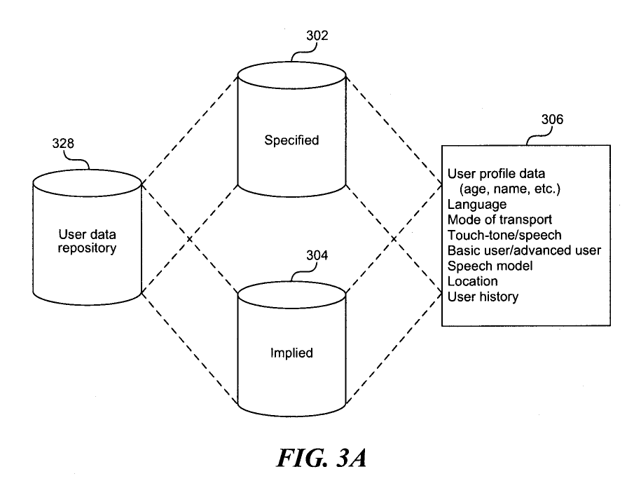

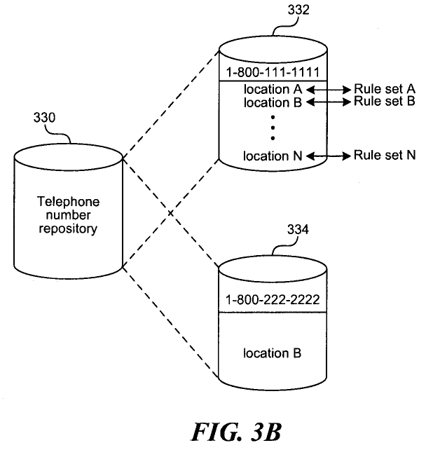

The repositories 128 and 130 can be implemented via object-oriented technology and/or via text files, and can be managed by a distributed database management system, an object-oriented database management system (OODBMS) (e.g., ConceptBase, FastDB Main Memory Database Management System, JDOInstruments, ObjectDB, etc.), an object-relational database management system (ORDBMS) (e.g., Informix, OpenLink Virtuoso, VMDS, etc.), a file system, and/or any other convenient or known database management package. An example set of data to be stored in the user data repository 128 and telephone number repository 130 is illustrated in FIG. 3A-3B.

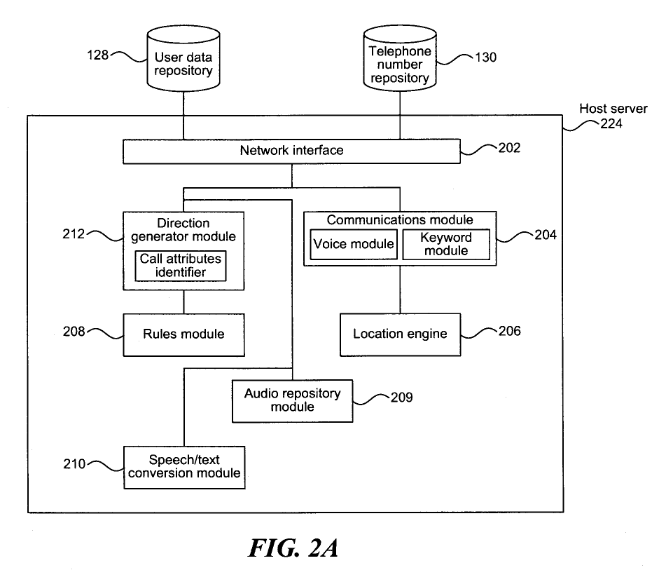

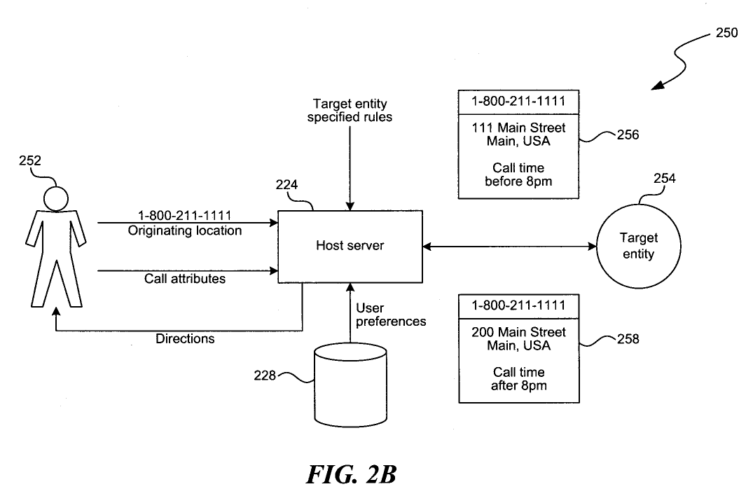

The host server 124 is, in some embodiments, able to communicate with cell phone devices 102A-N via the mobile wireless network 106, telephone devices 108A-N via the telephone network 112, and/or client devices 114A-N via the network 118. In addition, the host server 124 is able to retrieve data from user data repository 128 and telephone number repository 130. In some embodiments, the host server 124 assimilates, retrieves, and/or analyzes data obtained from the repositories 128/130 to generate directions requested from a user using (e.g., call, SMS text, Skype, or VoIP) a telephone number, which may be associated one a destination location or multiple destination locations based on rules. The functions and services provided by the host server are illustrated with further reference to the example of FIGS. 2A-2B.

The requests may be generated from portable devices or non-portable devices which can be the cell phone devices 102A-N, the telephone devices 108A-N, and/or the client devices 114A-N. In some embodiments, the host server 124 identifies data in the user data repository 128 to retrieve user preferences that further determine how the directions are generated and how they are delivered to the user.

FIG. 2A depicts a block diagram illustrating an example system to provide directions based on usage of a phone number that is associated with one or more destination locations based on rules, the system to include a host server 224 coupled to a user data repository 128 and/or a telephone number repository 130.

In the example of FIG. 2A, the host server 224 includes a network interface 202, a firewall (not shown), a communications module 204 having a voice module, a location processor 206, a rules module 208, an audio repository module 209, a speech/text conversion module 210, and/or a direction generator module 212. The host server 224 may be communicatively coupled to the user data repository 128 and/or the telephone number repository 130 as illustrated in FIG. 2A. In some embodiments, the user data repository 128 and/or the telephone number repository 130 are partially or wholly internal to the host server 224. In general, each of the modules in the host server 224 can be embodied in a computer-readable medium.

In the example of FIG. 2A, the network controller 202 can be one or more networking devices that enable the host server 224 to mediate data in a network with an entity that is external to the host server, through any known and/or convenient communications protocol supported by the host and the external entity. The network controller 202 can include one or more of a network adaptor card, a wireless network interface card, a router, an access point, a wireless router, a switch, a multilayer switch, a protocol converter, a gateway, a bridge, bridge router, a hub, a digital media receiver, and/or a repeater.

A firewall, can, in some embodiments, be included to govern and/or manage permission to access/proxy data in a computer network, and track varying levels of trust between different machines and/or applications. The firewall can be any number of modules having any combination of hardware and/or software components able to enforce a predetermined set of access rights between a particular set of machines and applications, machines and machines, and/or applications and applications, for example, to regulate the flow of traffic and resource sharing between these varying entities. The firewall may additionally manage and/or have access to an access control list which details permissions including for example, the access and operation rights of an object by an individual, a machine, and/or an application, and the circumstances under which the permission rights stand.

Other network security functions can be performed or included in the functions of the firewall, can be, for example, but are not limited to, intrusion-prevention, intrusion detection, next-generation firewall, personal firewall, etc. without deviating from the novel art of this disclosure. In some embodiments, the functionalities of the network interface 202 and the firewall are partially or wholly combined and the functions of which can be implemented in any combination of software and/or hardware, in part or in whole.

In the example of FIG. 2A, the host server 224 includes the communications module 204 or a combination of communications modules communicatively coupled to the network interface 202 to manage a one-way, two-way, and/or multi-way communication sessions over a plurality of communications protocols. The communications module 204 can, for example, receive data, information, and/or messages over a gateway which converts mobile wireless data to a TCP/IP based message. Therefore, for example, SMS based messages that originate from a portable wireless device is received from a gateway. In one embodiment, the communications module 204 receives information over a gateway which converts data, messages, text, audio data, and/or touch tone dials that originated from a telephone. Similarly, in one embodiment, the communications module 204 receives communications from a network (e.g., Internet) via a web-interface.

Since the communications module 204 is typically compatible with receiving and/or interpreting data originating from various communication protocols, the communications module 204 is able to establish parallel and/or serial communication sessions to receive requests for directions and/or to send directions to multiple users.

In addition, requests (e.g. queries) and responses can be provided, received, processed, sent, and/or assimilated in voice and/or text or any combination of such during various processes of generating or retrieving directions to a destination location that is associated with a phone number.

The communications module 204 can, in some embodiments, include a keyword module to process a text-based request. For example, the keyword module can parse a sentence and identify a set of keywords from the sentence. For example, text-based requests (e.g., SMS messages, USSD comments) can be managed by the text processor where further analysis can be performed in obtaining information about the request and attributes associated with the request for directions. In one embodiment, the keyword module extracts the originating location from the user request.

In a further embodiment, audio data/information gleaned from a voice-enabled communication session (e.g., from a portable device) can be relayed to a voice module for identifying the contents of the voice-based request or the voice-portion of the request, and, in particular, for identifying an address which may be indicative of the originating location from which the user wishes directions to be generated for. Alternatively, to process the request, the audio of the query can be converted to text, if necessary, for example, by the voice module before being provided to the location processor 206.

In some embodiments, the voice module can include any number of software and/or hardware components to provide one or more of sound detection functions, audio signal processing functions, speech recognition functions (e.g., automatic speech recognition, computer speech recognition), speech processing functions, voice recognition functions, to facilitate parsing the query and identifying the search parameters. For example, the voice module, may internally include, or be externally coupled to a microphone, such as dynamic microphones, ribbon microphones, condenser microphones, array microphone, or any type of transducer that converts sound into an electrical signal for the purposes of detecting sound. Any number of microphones as suitable depending on the application and/or environment can be used.

The voice module may further include software agents and/or hardware modules for speech recognition, as implemented by any known and/or convenient manner, such as, but is not limited to the Hidden Markov model (HMM)-based speech recognition and dynamic time warping (DTW)-based speech recognition. In other embodiments, the electrical signal representing sound may be sent to another module for sound processing, speech recognition and the like functions.

In some embodiments, the signals representing sound may be processed on the voice module and sent to another module/device for speech recognition and/or voice recognition (e.g., speaker recognition) purposes. Speech processing includes processing of a digital and/or analog signal, and by way of example but is not limited to, enhancement of speech signals (e.g., noise reduction), speech coding (e.g., signal compression, time compressed speech), voice analysis, speech synthesis, etc. The voice module, can include, one or more of, or any portion of the one or more of the above described functions, without deviating from the spirit of the novel art of the disclosure.

In general, the requesting user can select to have directions provided at any time, via any communication channel, in voice, text, and/or graphical formats, and/or to any devices. Additional combinations are contemplated and are considered to be within the scope of the disclosure. The communications module 204, can include, one or more of, or any portion of the one or more of the above described functions, without deviating from the spirit of the novel art of the disclosure.

The location engine 206 is any combination of hardware modules and/or software agents able to receive, retrieve, parse, analyze, and/or process data/information related to a user request for directions and identifying the destination location and/or originating location for which the directions are requested based on the phone number used by the user. The phone number is associated with the destination location and is used by the user via calling or SMS texting the phone number. In alternative embodiments, the phone number is generalized to any string of characters of any length. For example, the text string “flowerbob5” may be associated with the Bob's Flower shop on 5th street. The user can text or dial “flowerbob5” and obtain the directions or other desired information.

The engine 206 can be implemented via a computer-readable medium and/or a processor.

In the event that multiple destination locations are associated with the phone number, the location processor 206 communicates with the rules module 208 to determine which destination location is relevant for any given call. For example, the location processor 206 can communicate with the telephone number repository 130 to retrieve the destination location or the multiple destination locations associated with the phone number that the requesting user used to generate the request. The location processor 206 also receives the originating location associated with the request from the communications module 204.

In the event that one destination location is associated with the phone number, the location processor 206 provides the originating and destination locations to the direction generator module 212 such that directions can be retrieved or newly generated. In the event that multiple destinations are associated with the phone number, the location processor 206 communicates with the rules module 208 based on the telephone number information retrieved from the repository 130. The rules module 208 can retrieve various attributes of the request from the communications module 204 and assist the location processor 206 in identifying the relevant destination location for which a direction is to be generated. In one embodiment, at least one of the one or more destination locations for which the set of directions is to be provided is selected based on the set of rules.

In general the set of rules can include caller-based rules and/or time-based rules. The telephone number repository 130, in addition to maintaining a list of phone numbers and their associated destination locations, further includes a set of rules that determine which destination location is relevant given the circumstances that apply. The rules module 208, in one embodiment, is able to identify the rules that apply to each request. For example caller-based rules include destination locations that vary for a particular phone number based on the caller. Time-based rules include destination locations that vary for the particular phone number based on the time (e.g., time of day, day of week, month of year, year, etc.) that the request for directions was received.

The direction generator module 212 is any combination of hardware modules and/or software agents able to generate, retrieve, identify, modify, and/or optimize directions between an originating direction and the destination location.

The addresses for these directions are typically provided by the location processor 206. The directions may be newly generated on a per-request basis or they may be retrieved from a database if available. The directions are, in most instances, step-by-step, or turn-by-turn although less detailed directions may also be provided. In one embodiment, the direction generator module 212 identifies a set of call attributes associated with the request. For example, the call attributes may be identified by the call attributes identifier. The call attributes can include, by way of example but not limitation, a temporal attribute, a spatial attribute, a portable device attribute, and/or an identification of the user.

In one embodiment, the directions to the destination locations from the originating location is generated and provided based in part on call attributes. For example, if the request is placed at night rather than in the day time, the directions may be optimized to take larger streets as opposed to smaller alley ways. If the request is generated from a cell phone with an area code indicating that the caller is likely not from the nearby locale, more detailed locations may be automatically provided.

In addition, identification of the user, for example, by the call attributes identifier, allows user preferences to be identified. In one embodiment, the directions to the one or more destination locations from the originating location is further generated and provided based in part on user preferences.

The user preferences can include by way of example but not limitation, user-specified preferences and implied preferences. User preferences can include the user's preferred mode of transportation (e.g., bike, foot, car, train, bus, etc.), whether the user uses touch-tone or speech, whether the user prefers more or less detailed directions, etc. Note that these preferences can be automatically compiled by the system based on user history, for example.

Once the directions have been generated, they can be provided to the user device via the network interface 202. The delivery mechanism of the directions can also be specified by the user, either on a case-by-case basis or based on the user preferences. For example, the user may prefer to receive the instructions via email or text rather than via audio. In one embodiment, the directions may be delivered to the user step-by-step, or the full set of directions may be delivered to the user at once.

The host server 224 in the example of FIG. 2A, in accordance with one embodiment, further includes the audio repository module 209. The audio repository module 209 can be any combination of hardware modules and/or software agents able to store and/or read audio data, in a variety of formats, including, but not limited to, mp3, mp4, m4a, m4p, aac, wma, ra, wav, ogg, flac, aiff, raw, aw, DVD, CD, Blu-Ray, HD-DVD, DTS-CD, SACD, etc. The audio repository module 209 can be, in some embodiments, accessible by the direction generator module 212. For example, audio data (e.g., pre-recordings, synthesized audio tracks, speech, voice, music, etc.) can be retrieved from the audio repository module 209 by the direction generator module 212.

The audio track can include, for example, but is not limited to, speech to provide for instructions, prompt users for information, and/or soundtracks for background music. In some embodiments, the audio repository module 209 includes standard voice greetings, voice-based instructions for users of the mobile social network. The audio repository module 209 may further include digital signal processors (DSP) that support generation of digital music files and/or audio effects/mixing.

The speech/text conversion module 210 can be any combination of hardware modules and/or software agents able to convert speech to text and/or vice versa. In some embodiments, the conversion module 210 is able to convert text to speech (e.g., synthesized speech) for transmission over an audio-enabled device (e.g., portable phone, telephone, VoIP, voice-enabled IM chat service, etc.). The conversion module 210 may further be able to synthesize voice according to selected dialects or languages, based on user settings. In addition, the conversion module 210 can include speech recognition functions to convert speech data into text-based data to be presented to users for example, via SMS and/or web-based chat services.

The host server 224 can be implemented using one or more processing units, such as server computers, UNIX workstations, personal computers, and/or other types of computes and processing devices. In the example of FIG. 2A, the host server 224 includes multiple components coupled to one another and each component is illustrated as being individual and distinct. However, in some embodiments, some or all of the components, and/or the functions represented by each of the components can be combined in any convenient and/or known manner. For example, the components of the host server may be implemented on a single computer, multiple computers, and/or in a distributed fashion.

Thus, the components of the host server 224 are functional units that may be divided over multiple computers and/or processing units. Furthermore, the functions represented by the devices can be implemented individually or in any combination thereof, in hardware, software, or a combination of hardware and software. Different and additional hardware modules and/or software agents may be included in the host server 224 without deviating from the spirit of the disclosure.

FIG. 2B is a diagrammatic view 250 illustrating the example interactions between various entities in the process of retrieving or generating directions based on usage of a phone number that is associated with one or more destination locations.

The caller 252 generates a request for directions for the business, establishment, or event (e.g., target entity 254) using the phone number (“1-800-211-1111”), for example, via a portable device. The request can be generated, for example, via a placed phone call or an SMS text message. The call attributes associated with the request (call or SMS) can be retrieved by the host server 224. The host server 224, in one embodiment, also manages the target entity specified rules, if applicable. These rules determine which address is the destination location associated with the phone number that the user 252 used to generate the request for directions. For example, if the user called before 8 PM, then the address of 256 (“111 Main Street, Main, USA”) is used as the destination address, after 8 PM, the address of 258 (“200 Main Street, Main, USA”) is used as the destination address.

Once the host server 224 has identified the destination address, directions may be generated and/or retrieved and provided to the user 252. Note that the host server 224 can optionally use the call attributes and/or user preferences (in repository 228) to refine or optimize the directions and how it can be delivered to the user 252.

FIG. 3A depicts a block diagram illustrating an example user data repository to store user profiles with specified and/or implied user preferences.

In the example of FIG. 3A, the database 328 can store user profile data (e.g., user data, user metadata, user information, etc.), including user information of the service subscribers of wireless services and/or any other users, and/or any other user information about the user specified by the user or inferred from the user (e.g., based on user activity and historical behavior). For example, user profile data can include descriptive data of personal information such as, but is not limited to, a first name and last name of the user, a valid email ID, a unique user name, age, location, education, etc.

User profile data stored in database 328 may be explicitly specified by the user (e.g., repository 302) or inferred from user behavior (e.g., repository 304). For example, when the user (e.g., visitor or service subscriber) signs up for wireless services and/or telephone services, a set of information may be required, such as a valid email address, an address of service, a valid credit card number, social security number, a username, and/or age.

An example list 306 of user information can include, but is not limited to, preferred language(s), preferred modes of transportation, preference of touch-tone or speech, whether the user is a basic user or an advanced user, a suitable speech model, location, and/or other user history.

FIG. 3B depicts a block diagram illustrating an example telephone number repository 330 to store phone numbers and their associated locations and/or any applicable rules.

In the example of FIG. 3B, the repository 334 illustrates how a phone number can be associated with a single location or destination location. Repository 332 illustrates an example of how a phone number can be associated with multiple locations based on rules A-N. Each of the rules A-N may include a caller-based rule, a time-based rule, and/or a combination of time-based and caller-based rules or other types of rules. Each rule can be considered as a set of conditions that when met, causes the associated location (e.g., locations A-N) to be the destination location for which directions are to be generated.

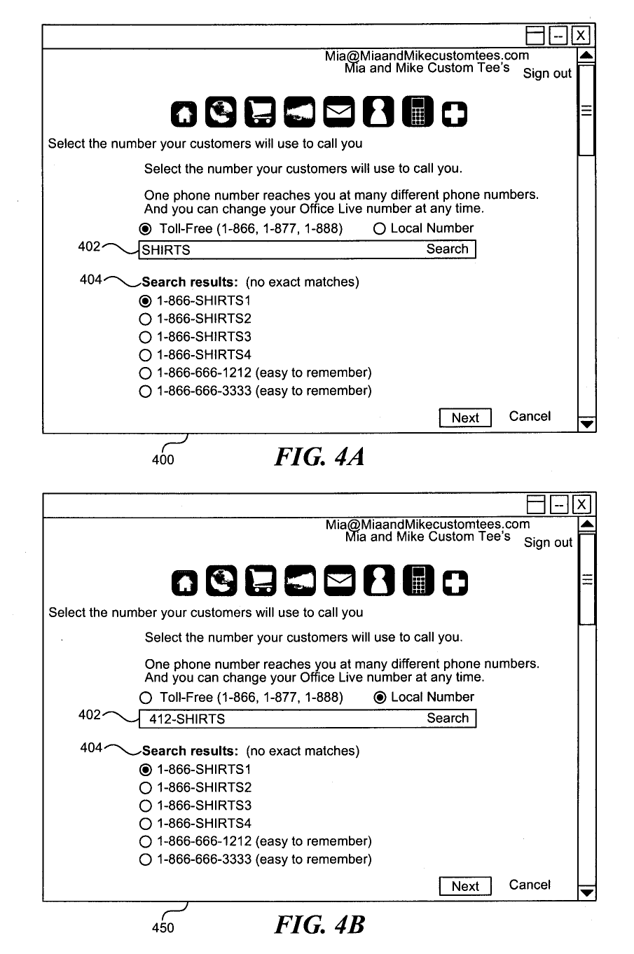

FIG. 4A-B illustrates example user interfaces 400 and 450 for a business, establishment, or representative for an event to select a phone number.

For example, the phone number can be selected to be a toll-free number or a local number. The desired phone number of sub-combination of the phone number may be searched for in field 402. The search results are, in one embodiment, displayed in field 404.

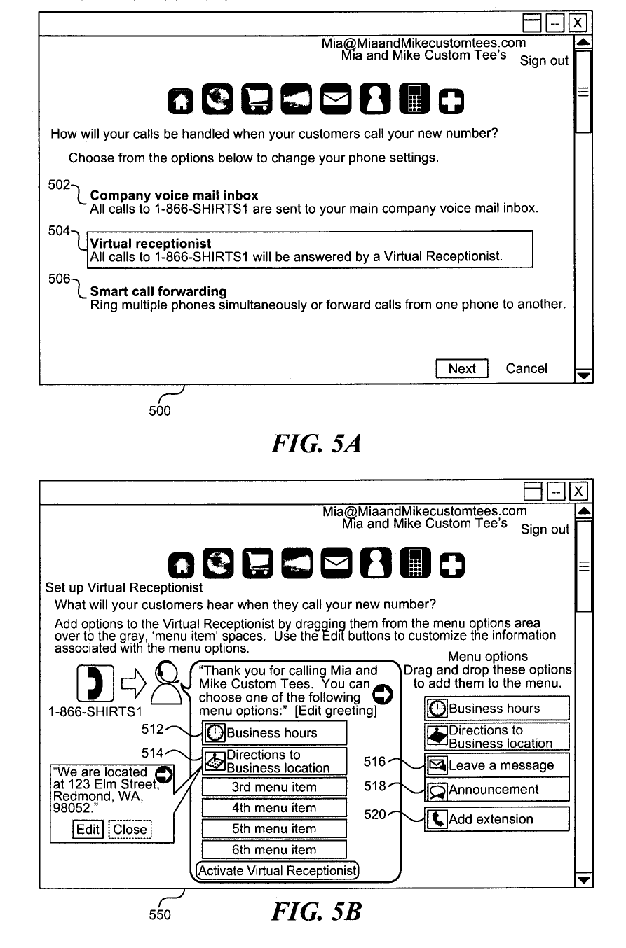

FIG. 5A-B illustrates example user interfaces 500 and 550 for a business, establishment, or representative for an event to setup customized information associated with the selected telephone number.

For example, the phone number can be set up to be directed to a voice mail inbox 502, a virtual receptionist 504, and/or forwarded to other phones 506. In one embodiment, the virtual receptionist option enables the business to customize a greeting when the phone number is dialed. In the example of FIG. 5B, the business can select to have any number of the default elements be included in the greeting. For example, the elements that the business can choose from include but are not limited to, business hours 512 and the business location 514.

When the business location is selected by a caller, directions to the business location can be provided in accordance with embodiments of the present disclosure. In addition, the business can enable the caller to leave a message 516, hear an announcement 518, and/or add an extension 520.

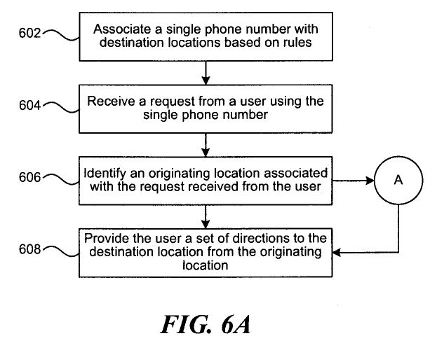

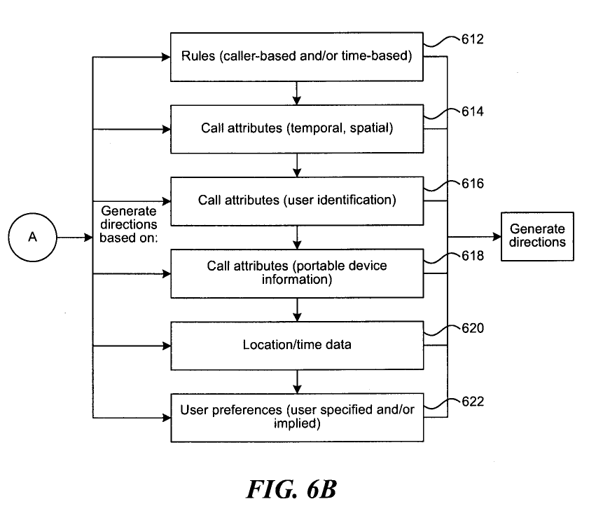

FIG. 6A depicts a flow diagram illustrating an example process of providing directions to a user using the phone number associated with one or more destination locations based on a set of rules.

In process 602, a phone number is associated with a destination. In general, multiple destination locations can be associated with the phone number. The destination location that is relevant when the phone number is used by an end user is typically governed by the associated set of rules which may be caller-based, time-based, or based on some other type of selection criteria. One location may be associated with the phone number for certain periods of times while another location may be associated with the phone number for certain other periods of times. For example, an on-site business address may be associated with business hours while an off-site delivery address may be associated with non-business hours.

Similarly, different destinations may be associated with the phone number based on the caller. For example, the destination location can be associated with a business location when a caller is a customer and the destination may be an off-site storage location of the business when the caller is a delivery man.

Another example application includes a phone number which is associated with an event such as a party or other types of gathering. Since party attendees may arrive at the event at varying times, the group of attendees may have moved to another location. For example, the event may initially take place at a restaurant and then at a concert venue. In this case, the party planner or other event coordinator could set up the phone number such that it is associated with addresses for both the restaurant and the concert venue. If a party attendee called before a certain time, then the directions for the restaurant could be provided. Alternatively, if the party attendee called after a certain time, then the directions for the concert venue could be provided.

In process 604, a request from a user using the phone number is received. The request may be generated by the user via portable device, for example, when the user calls or sends a text message to the phone number. After the request has been sent, the user can be presented with a standard or customized greeting which may include a prompt (e.g., audio and/or text) for an address of the originating location for which the directions are to be generated. The greeting may also include typical information such as business address or business hours, etc.

In process 606, an originating location associated with the request received from the user is identified. The originating location is, in some instances, a current location of the user or user device and may be automatically identified if the user is using a location-aware device. The current location may also be manually submitted by the user, for example, via voice or text, and/or other convenient means. The originating location may also be another specified address different from that of the user's current location. This address may be manually submitted by the user.

The request can further be associated with call attributes including but not limited to, a temporal attribute, a spatial attribute, a portable device attribute, and identification of the user. The temporal attribute may be associated with when the request is placed, for example and may be determined by identifying a timestamp or other metadata associated with the call. A spatial attribute can be associated with, for example, the location where the user is calling from and may be identified by the area code or other metadata associated with the call. The user may be identified based on the originating phone number thus enabling user preferences to be determined or retrieved from a user data repository. In one embodiment, the directions are generated taking call attributes and/or user preferences into account, as illustrated with further reference to FIG. 6B.

In process 608, the user is provided with a set of directions to the destination location from the originating location. The directions to the destination location from the originating location can be provided based in part on one or more of the set of call attributes and/or user preferences.

FIG. 6B depicts a table illustrating examples of variables that can be taken into account when generating directions based on a particular destination and originating direction.

As shown, the variables may includes rules 612 that are caller-based and/or time-based, call attributes 614 that are temporal and/or spatial, call attributes 616 that are related to identification of the user, call attributes 168 that are related to information (e.g., hardware ID, model, version, etc.) of the user's device (e.g., portable device), data or other metadata 620 related to location/time, and/or user preferences 622 including but not limited to user specified and/or implied preferences.

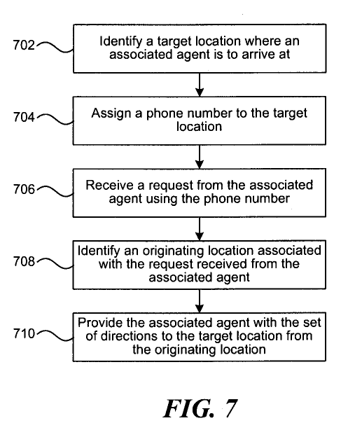

FIG. 7 depicts a flow diagram illustrating another example process of providing directions to an associated agent using the phone number associated with a target location.

In process 702, a target location where an associated agent is to arrive at is identified. In some instances, the target location is provided by a dispatcher or an operator. The target location may also be provided via a feed from a tracking system. The target location can be a site of emergency where the associated agent (e.g., emergency medical technician or other health care provider) is to arrive at. For example, the target location may be assigned by a 911 dispatcher or other emergency services dispatcher. In other instances, the target location may be a site for pizza delivery and the associated agent is a pizza delivery person. In this case, the target location may be provided by a dispatcher to the pizza delivery person.

In process 704, a phone number is assigned to the target location. Therefore, the associated agent (e.g., emergency medical technician or pizza delivery person) can use the assigned phone number to obtain step-by-step directions to the target location (e.g., site of emergency or site for pizza delivery).

In process 706, a request from the associated agent using the phone number is received. Once the assigned number has been received by the agent, the agent can generate the request for directions using the telephone number (e.g., by calling and/or SMS text-ing). Once the request has been received, the associated agent may be prompted for his/her current location or another originating location.

In process 708, an originating location associated with the request received from the associated agent is identified. The originating location may be automatically identified using GPS coordinates if the associated agent is using a location-aware device. The originating location may also be manually entered by the agent (e.g., via voice and/or text).

In process 710, the associated agent with the set of directions to the target location from the originating location is provided. The set of directions may be provided in any known and/or convenient means including but not limited to, audio (e.g., recorded audio, live audio, etc.), SMS text message, email, etc. The directions may be turn-by-turn or less detailed per default settings or user preferences.

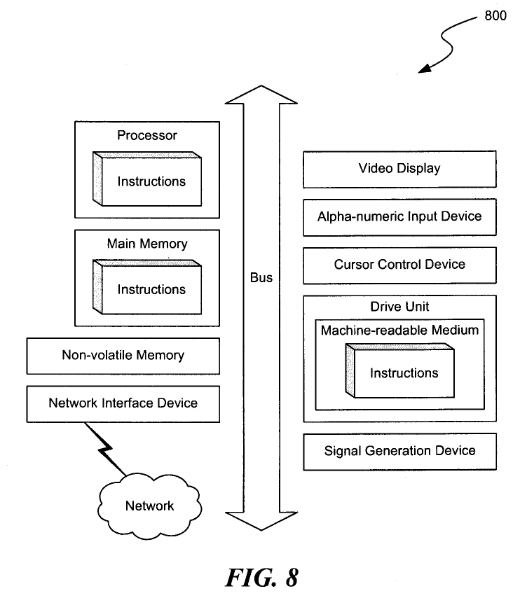

FIG. 8 shows a diagrammatic representation of a machine 800 in the example form of a computer system within which a set of instructions, for causing the machine to perform any one or more of the methodologies discussed herein, may be executed.

In alternative embodiments, the machine operates as a standalone device or may be connected (e.g., networked) to other machines. In a networked deployment, the machine may operate in the capacity of a server or a client machine in a client-server network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone, a web appliance, a network router, switch or bridge, or any machine capable of executing a set of instructions (sequential or otherwise) that specify actions to be taken by that machine.

While the machine-readable medium is shown in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention.

In general, the routines executed to implement the embodiments of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processors in a computer, cause the computer to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution.

Further examples of machine or computer-readable media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of embodiments of the disclosure is not intended to be exhaustive or to limit the teachings to the precise form disclosed above. While specific embodiments of, and examples for, the disclosure are described above for illustrative purposes, various equivalent modifications are possible within the scope of the disclosure, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other systems, not necessarily the system described above. The elements and acts of the various embodiments described above can be combined to provide further embodiments.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further embodiments of the disclosure.

These and other changes can be made to the disclosure in light of the above Detailed Description. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

While certain aspects of the disclosure are presented below in certain claim forms, the inventors contemplate the various aspects of the disclosure in any number of claim forms. For example, while only one aspect of the disclosure is recited as a means-plus-function claim under 35 U.S.C. §112, ¶6, other aspects may likewise be embodied as a means-plus-function claim, or in other forms, such as being embodied in a computer-readable medium. (Any claims intended to be treated under 35 U.S.C. §112, ¶6 will begin with the words “means for”.) Accordingly, the applicant reserves the right to add additional claims after filing the application to pursue such additional claim forms for other aspects of the disclosure.

I/We claim:

1. A method, comprising:
associating a phone number with one or more destination locations based on a set of rules;
receiving a request from a user using the phone number; wherein the request is associated with accessing a set of directions to at least one of the one or more destination locations;
identifying an originating location associated with the request received from the user; and
providing the user with at least one of the sets of directions to the one or more destination locations from the originating location.

2. The method of claim 1, wherein the request from the user is generated from a portable device.

3. The method of claim 2, wherein, the portable device is a location-aware device, and, wherein, the originating location is provided by the portable device.

4. The method of claim 1, further comprising, identifying a set of call attributes associated with the request, the set of call attributes comprising, one or more of, a temporal attribute, a spatial attribute, a device attribute, and identification of the user.

5. The method of claim 1, wherein, the request is generated when the user calls or sends a text message to the phone number, wherein, the originating location is submitted by the user via voice or text.

6. The method of claim 1, wherein, the at least one of the sets of directions is audibly provided.

7. The method of claim 1, wherein, the at least one of the sets of directions is provided via text or a visual map display.

8. The method of claim 1, wherein, the at least one of the one or more destination locations for which the set of directions is to be provided is selected based on the set of rules.

9. The method of claim 1, further comprising, identifying a set of user preferences of the user, wherein, the set of user preferences comprises user-specified preferences and implied preferences.

10. The method of claim 9, wherein, the set of rules comprises, one or more of, a caller-based rule and a time-based rule.

11. The method of claim 10, wherein, the at least one of the one or more destination locations are selected based on, one or more of, the caller-based rule and the time-based rule.

12. The method of claim 11, wherein, at least one of the sets of directions to the one or more destination locations from the originating location is generated and provided based in part on one or more of the set of call attributes.

13. The method of claim 12, wherein, at least one of the sets of directions to the one or more destination locations from the originating location is generated and provided based in part on one or more of the set of user preferences.

14. A method, comprising:
identifying a target location where an associated agent is to arrive at; wherein the target location is associated with a phone number;
receiving a request from the associated agent using the phone number; wherein the request is associated with access to a set of directions to the target location;
identifying an originating location associated with the request received from the associated agent; and
providing the associated agent with the set of directions to the target location from the originating location.

15. The method of claim 14, further comprising, assigning the phone number to the target location.

16. The method of claim 14, wherein, the target location is provided by a dispatcher or operator.

17. The method of claim 14, wherein, the target location is automatically provided via a feed from a tracking system.

18. The method of claim 14, wherein, the target location is a site of emergency and the associated agent is an emergency medical technician or a health care provider.

19. The method of claim 14, wherein, the target location is a site for pizza delivery.

20. A system, comprising:
a communications module embodied in a computer-readable medium, the communications module to communicate with a user device; wherein, in operation, the communications module receives a request generated by a user using a telephone number and the request is associated with accessing a set of directions to a destination location of a set of destination locations associated with the telephone number;
a rules module embodied in a computer-readable medium, the rules module to manage a set of rules that govern the set of destination locations associated with the telephone number;
a user data repository to store user data;
a telephone number repository to store the telephone number and the set of destination locations governed by the set of rules;
a location engine coupled to the rules module to identify an originating location associated with the request received from the user; wherein, in operation, the location processor communicates with the communications module to determine the location of the user device; and
a direction generator module embodied in a computer-readable medium, coupled to the rules module and the location processor; wherein, in operation, the direction generator module generates a set of directions from the originating location to the destination location based on one or more of user data and the set of rules.
